(19) United States
(12) Patent Application Publication
(10) Pub. No.: US 2013/0073709 A1
(43) Pub. Date: Mar. 21, 2013

(54) COMMUNICATION APPARATUS

(71) Applicant: Panasonic Corporation, Osaka (JP)

(72) Inventors: TAKEHITO YAMAGUCHI, Osaka (JP); HIDEKI TANIGUCHI, Kyoto (JP)

(73) Assignee: PANASONIC CORPORATION, Osaka (JP)

(21) Appl. No.: 13/622,557

(22) Filed: Sep. 19, 2012

(30) Foreign Application Priority Data
Sep. 21, 2011 (JP) 2011-205429

(51) Int. Cl. G06F 15/173

(52) U.S. Cl. 709/223; 709/230

(57) ABSTRACT

According to one embodiment, a communication apparatus includes a communication protocol processor configured to process a communication protocol based on a predetermined standard, and a communication unit configured to perform communication processing with a communication apparatus as a transmission destination of data under a control of the communication protocol processor. The communication protocol processor includes model identification information of the communication apparatus in a transmission command defined in the communication protocol as extended information of the predetermined standard.

### BACKGROUND

1. Technical Field

The present disclosure relates to a communication apparatus that transmits or receives content such as images.

2. Related Art

A technology to exchange image data or the like by performing communication between a client apparatus and a server apparatus is widely used. For example, Japanese Patent Application Laid-Open No. 2004-229177 discloses an image management system capable of uploading images captured by a mobile phone with a camera from an image service terminal to an image management center on the Internet.

### SUMMARY

While a system in which a client apparatus and a server apparatus exchange image data is useful, there is the risk of a large amount of image data being sent from many and unspecified terminals. Particularly, it is necessary to avoid a situation in which the server apparatus runs out of capacity after a large amount of image data being sent from client apparatuses of malicious users.

To solve the above subject, a first object of the embodiments is to provide a communication apparatus that transmits or receives content data more appropriately.

A second object thereof is to provide a communication apparatus capable of transmitting content in the same manner (the same communication protocol) without distinguishing a communication apparatus capable of restricting reception of content while maintaining compatibility with image transmitting/receiving systems widely used as standard and a communication apparatus conforming to reception restrictions on the receiving side.

A communication apparatus according to an aspect of the present disclosure includes a communication protocol processor configured to process a communication protocol based on a predetermined standard, and a communication unit configured to perform communication processing with a communication apparatus as a transmission destination of data under a control of the communication protocol processor, wherein the communication protocol processor includes model identification information of the communication apparatus in a transmission command defined in the communication protocol as extended information of the predetermined standard.

A communication apparatus according to another aspect of the present disclosure includes a communication protocol processor configured to process a communication protocol based on a predetermined standard, and a communication unit configured to perform communication processing with a communication apparatus of a transmission source of data under a control of the communication protocol processor, wherein when extended information of the predetermined standard is contained in a received command defined in the communication protocol, the communication protocol processor restricts communication from the communication apparatus as the transmission source of the data in accordance with whether or not the extended information is model identification information.

According to the present disclosure, a communication apparatus that transmits or receives content data more appropriately can be provided.

### BRIEF DESCRIPTION OF DRAWINGS

FIG. 1 is a diagram showing a data communication system according to a first embodiment;

FIG. 2 is a block diagram showing an electric configuration of a digital camera in FIG. 1;

FIG. 3 is a block diagram showing the electric configuration of a personal computer in FIG. 1;

FIG. 4 is a flow diagram showing a communication protocol according to the first embodiment;

FIG. 5 is a diagram showing an object creation request according to the first embodiment;

FIG. 6 is a determination flow of a protocol determination unit according to the first embodiment;

FIG. 7 is a diagram showing a data communication system according to the first embodiment;

FIG. 8 is a flow showing the communication protocol according to a second embodiment;

FIG. 9 is a flow showing the communication protocol according to a third embodiment;

FIG. 10 is a diagram showing the object creation request according to a modification; and

FIG. 11 is a diagram showing the data communication system according to a fourth embodiment.

### DETAILED DESCRIPTION OF PREFERRED EMBODIMENT

The embodiments will be described in detail below with reference to the drawings when appropriate. However, a description more detailed than necessary may be omitted. For example, a detailed description of well-known matter or a duplicate description of substantially the same configuration may be omitted. This is intended to avoid unnecessary redundancy of the description below to facilitate the understanding of persons skilled in the art. The inventors provide appended drawings and the description below so that persons skilled in the art can fully understand the present disclosure and do not intend to limit subject matter described in the scope of claims. First, an embodiment will be described by taking a digital camera and a personal computer as examples of the communication apparatus.

### First Embodiment

[0. Overview]

First, an overview of the first embodiment will be provided.

As will be described later, a digital camera according to the first embodiment includes a communication protocol processor and a communication unit. The communication protocol processor is a function of a controller of the digital camera.

The communication protocol processor processes a communication protocol based on a standard and further embeds model identification information of the digital camera in a transmission command defined in the communication protocol as extended information of the predetermined standard. The communication unit performs communication processing with a data transmission destination apparatus under the control of the communication protocol processor.

A personal computer (hereinafter, referred to as a PC) according to the first embodiment includes a communication protocol processor and a communication unit. The communication protocol processor is a function of a controller of the PC.

The communication protocol processor processes a communication protocol based on a standard and further determines first whether non-standard extended information is embedded in a reception command defined by the communication protocol. Secondly, if the extended information is embedded, the communication protocol processor determines whether the extended information is model identification information. Thirdly, if the extended information is model identification information, the communication protocol processor determines whether the transmission source apparatus is a content transmission permitted apparatus based on the value thereof. If the transmission source apparatus is determined to be a content transmission permitted apparatus in the third determination, the communication protocol processor returns a reply indicating that content can be received to a remote communication apparatus (transmission source apparatus). On the other hand, if no extended information is embedded in the first determination, extended information is embedded, but is not model identification information in the second determination, or extended information is model identification information, but the transmission source apparatus is not a content transmission permitted apparatus in the third determination, the communication protocol processor returns a reply indicating that content cannot be received to a remote communication apparatus (transmission source apparatus). The communication unit performs communication processing with a data transmission source apparatus under the control of the communication protocol processor.

By adopting the above configuration, a digital camera capable of transmitting content in the same manner (the same communication protocol) without distinguishing communication apparatuses conforming to reception restrictions on the receiving side from those not conforming to reception restrictions. Further, a PC capable of restricting reception of content while maintaining compatibility with image transmitting/receiving systems widely used as standard can be provided.

A communication system according to the first embodiment and a digital camera and a PC constituting the communication system will be described below using the drawings. In the description that follows, an example in which a digital camera is used as a communication apparatus of the data transmission source and a PC is used as a communication apparatus of the data transmission destination is taken. However, the communication apparatus is not limited to the above example.

[1. Configuration]

[1-0. Configuration Example of a Communication System]

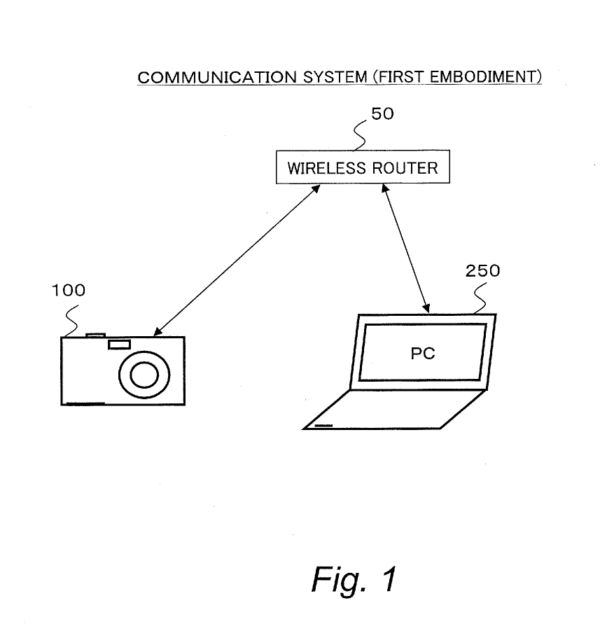

First, a configuration example of a communication system according to the first embodiment will be described by using FIG. 1.

As illustrated in FIG. 1, the communication system according to the first embodiment is configured by two communication apparatuses connected with a LAN via a wireless router 50. Each of a digital camera 100 and a PC 250 is, for example, a communication apparatus that communicates image data or the like bidirectionally. The digital camera 100 corresponds to a communication apparatus as the data transmission source and the PC 250 corresponds to a communication apparatus as the data transmission destination.

As illustrated in FIG. 1, the digital camera 100 and the PC 250 are connected with a LAN via the wireless router 50. The digital camera 100 is, among communication apparatuses according to the first embodiment, a communication apparatus of the transmission source that transmits content such as photo data. The PC 250 is a communication apparatus as the transmission destination that receives content such as photo data to be transmitted. Here, a case where photo data photographed by the digital camera 100 is transmitted to the PC 250 is taken as an example.

Next, the configuration of the digital camera 100 and the personal computer 250 will be described.

[1-1. Configuration Example of the Digital Camera 100]

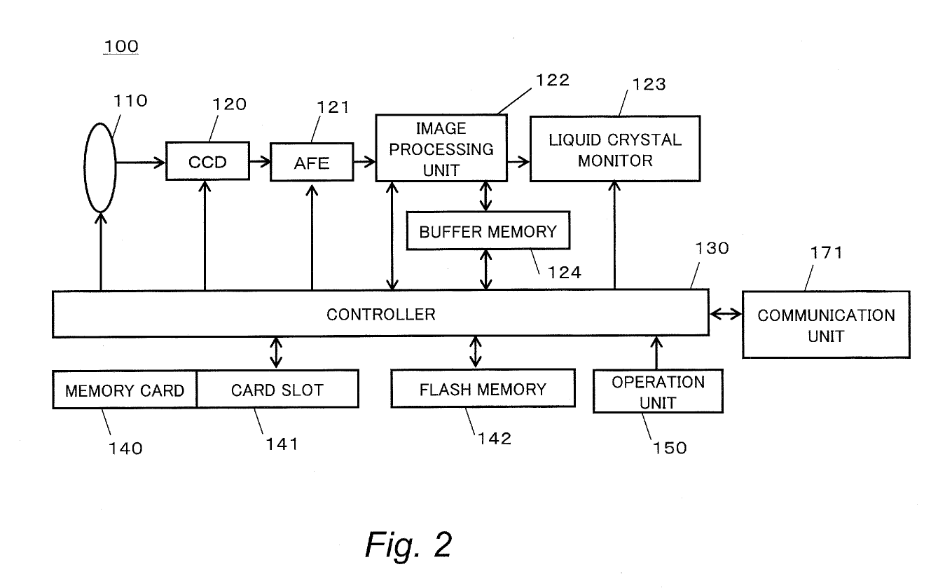

FIG. 2 is an electric block diagram of the digital camera 100. The digital camera 100 captures a subject image formed via an optical system 110 by a CCD image sensor 120. The CCD image sensor 120 generates image data based on the captured subject image. Various kinds of processing are performed by an AFE (analog frontend) 121 and an image processor 122 on image data generated by capturing a subject image. The generated image data is recorded in a flash memory 142 or a memory card 140. The image data recorded in the flash memory 142 or the memory card 140 is displayed on a liquid crystal monitor 123 after an operation of an operation unit 150 by the user is received.

A controller 130 controls an overall operation of the digital camera 100 in a unified manner. The controller 130 may be configured by a hard-wired electronic circuit or a microcomputer. The controller 130 may also be configured as a semiconductor chip together with the image processor 122.

The flash memory 142 functions as an internal memory to record image data and the like.

A buffer memory 124 is a storage unit functioning as a work memory of the image processor 122 or the controller 130. The buffer memory 124 is realized by, for example, a DRAM (Dynamic Random Access Memory).

A card slot 141 is a connection unit from which the memory card 140 can be removed. The card slot 141 can connect the memory card 140 electrically and mechanically. The card slot 141 may also include a function to control the memory card 140.

A communication unit 171 is a wireless or wired communication interface. The controller 130 can connect to a LAN or an Internet network through an access point via the communication unit 171. The communication unit 171 is realized by, for example, USB, Bluetooth (registered trademark), wireless LAN, cable LAN or the like.

The operation unit 150 is a generic name for operation buttons and an operation lever provided on the exterior of the digital camera 100 and receives an operation by the user. When an operation by the user is received, the operation unit 150 notifies the controller 130 of various operation instruction signals.

[1-2. Configuration of the Personal Computer 250]

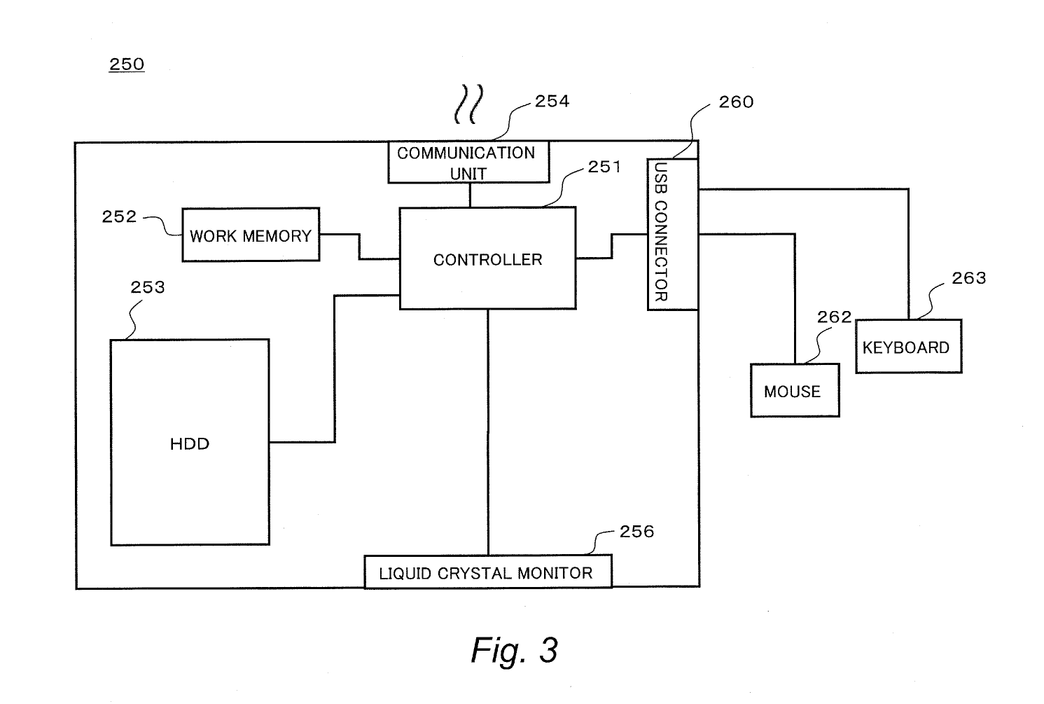

Next, the configuration of the personal computer 250 will be described by using FIG. 3. FIG. 3 is an electric block diagram of the PC 250.

As illustrated in FIG. 3, the PC 250 includes a controller 251, a work memory 252, an HDD 253, a communication unit 254, a liquid crystal monitor 256, a USB connector 260, a mouse 262, and a keyboard 263.

The controller 251 is a processor that performs processing on the PC 250. The controller 251 is electrically connected to the work memory 252, the HDD 253, the communication unit 254, the liquid crystal monitor 256, the USB connector 260, the mouse 262, and the keyboard 263. The controller 251 receives operation information of the user using the mouse 262 or the keyboard 263 via the USB connector 260. The controller 251 can read data stored in the HDD 253. Also, the controller 251 controls the system of power supplied to each unit of the PC 250 as a whole.

The work memory 252 is a memory to temporarily store information necessary to perform various processing operations by the controller 251.

The HDD 253 is a large-capacity disk drive to store various kinds of data. As described above, various kinds of data stored in the HDD 253 are read by the controller 251 where relevant.

The mouse 262 is a pointing device that receives an operation by the user. The keyboard 263 is a keyboard device in which the user enters characters or the like.

The USB connector 260 is an interface that connects a USB connector of another device via a USB cable. The controller 251 can transmit/receive information to/from the other device via the USB connector 260 and the USB cable. The USB connector 260 is connected to the digital camera 100, the mouse 262, the keyboard 263 or the like.

The communication unit 254 transmits image data received from the controller 251 to another device via a LAN or an Internet network. The communication unit 254 can be realized by, for example, a cable LAN or a wireless LAN.

[2. Operation]

Next, the communication operation between the digital camera 100 and the PC 250 will be described.

Here, the user of the digital camera 100 takes an operation to transfer a photo file stored in a memory card or flash memory of the digital camera 100 to the personal computer 250 as an example.

The digital camera 100 is mounted with a client function that transmits images to an image receiving server. The client function is realized by predetermined software being executed on the controller 130 when an image is transmitted. Hereinafter, the present software will be called “UPLOAD client software”. The UPLOAD client software communicates with the PC 250 by means of TCP/IP stack software and communication driver software. The communication driver software is software to control the communication unit that executes WiFi communication. The TCP/IP stack software and communication driver software are also executed on the controller 130. The image receiving server is, for example, a server configured by including predetermined functions that receive transmitted image data and make the received image data accessible.

In this operation, the PC 250 has a server program that receives image content, the server program being installed in advance and activated on the controller 251 as a resident task. The server program communicates with the digital camera 100 by means of the TCP/IP stack software and communication driver software. The communication driver software is software to control the communication unit that executes WiFi communication. The TCP/IP stack software and communication driver software are also executed on the controller 251.

The client function of the digital camera 100 and the server program establish a connection to transfer data according to a communication protocol. As the communication protocol, the DMS protocol provided by DLNA (Digital Living Network Alliance) is known. In the DMS protocol, in addition to indispensable functions, some optional functions are defined. In the first embodiment, images are transmitted (uploaded) from client to server. Thus, a case where an optional function of UPLOAD of the DMS protocol is used is taken as an example.

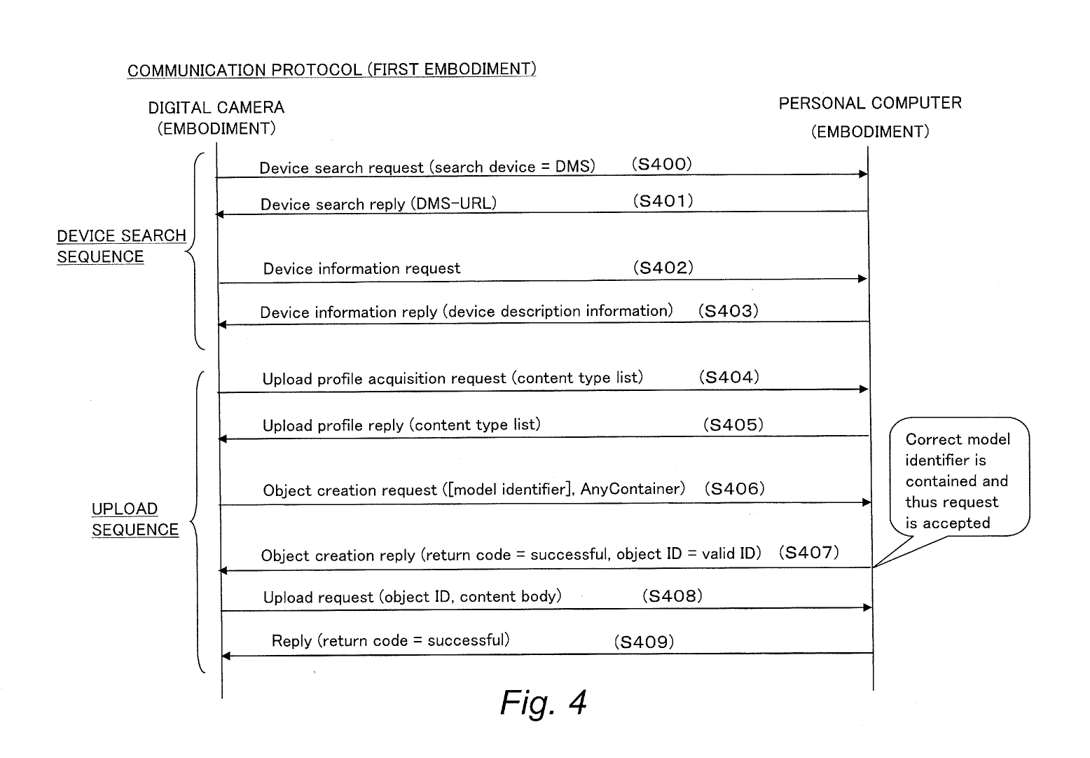

FIG. 4 is a diagram showing a communication sequence between the digital camera 100 according to the first embodiment and the personal computer 250 according to the first embodiment. A sequence of operation will be described below based on FIG. 4.

2-1. Device Search Sequence

First, a device search sequence will be described. When the user of the digital camera 100 wants to transfer a photo file stored in the memory card 140 or the flash memory 124 of the digital camera 100 to the personal computer 250, the user turns on the digital camera 100. The user follows instructions displayed in the liquid crystal monitor 123 to switch to the photo transfer mode. When switched to the photo transfer mode, the liquid crystal monitor 123 displays a “Transmission destination search” button. If the “Transmission destination search” button is pressed, the digital camera 100 transmits a device search request (search device=DMS) to the personal computer 250 (S400). The search device type needs to be specified for the device search request and here, the DMS is specified.

The PC 250 has a DMS server function, which corresponds to the search device (DMS), and thus returns a device search reply to the digital camera 100 (S401). In this case, the PC 250 includes the access destination URL used to make a device information request to the device search reply as DMS-URL.

When the device search reply is received, the digital camera 100 transmits a device information request to the PC 250 by setting DMS-URL as the access destination (S402).

The PC 250 returns device description information of the local apparatus to the digital camera 100 as a device information reply (S403). According to the DMS protocol, if the local apparatus corresponds to an upload option, the server program provides device description information describing the above situation. In the present embodiment, the PC 250 corresponds to an upload option and the device description information has the above situation described therein. This completes the device search sequence.

2-2. Upload Sequence

Subsequently, an upload sequence of photo data will be described.

When a device information reply is received, the controller 130 of the digital camera 100 determines whether the PC 250 corresponds to an upload option from the device description information. If the PC 250 does not correspond to any upload option, the digital camera 100 terminates the device search processing by displaying “Transmission destination cannot be found” in the liquid crystal monitor 123. In the present embodiment, the PC 250 corresponds to an upload option and thus, the digital camera 100 transmits an upload profile acquisition request to the PC 250 (S404). In this case, the digital camera 100 sets a content type list describing content types that can be handled by the own apparatus (the local apparatus) to the upload profile acquisition request.

When the upload profile acquisition request is received, the PC 250 checks the content type list to create a content type list containing, among content types in the list, only content types supported by its own apparatus. Then, the PC 250 adds the content type list to an upload profile reply and returns the upload profile reply to the digital camera 100 (S405).

When the upload profile reply is received, the digital camera 100 checks the content type list contained therein and, if the content list is not empty, displays a message “Transmission destination is found” and a “device name” in the liquid crystal monitor 123. The “device name” is already received as one piece of the device description information. A value indicating the PC 250 is set to the device name and thus, the user can make sure that the transmission destination is the predetermined personal computer. If the content type list is empty, the digital camera 100 displays a message “Transmission destination cannot be found” in the liquid crystal monitor 123.

After making sure that the “device name” of the personal computer is displayed in the liquid crystal monitor 123 by the device search processing, the user switches the digital camera to the image selection mode according to instructions of the digital camera. In image selection mode, only content types replied as being supported by the PC 250 can be selected as uploadable images. If the user instructs to upload after selecting images, the digital camera 100 transmits an object creation request to the personal computer 250 (S406).

In the present embodiment, the controller 130 of the digital camera 100 adds “model identification information” that is not defined in the DMS-UPLOAD standard protocol to the object creation request (transmission command) as extended information and then transmits the object creation request to the PC 250. The extended information refers to information that can freely be described by the manufacturer of the communication apparatus. The “model identification information” includes an “extension tag” indicating a protocol extension and a “model ID” identifying the model. In the present embodiment, a value indicating the digital camera 100 in the first embodiment is set to the “model ID”. Thus, in the first embodiment, the digital camera 100 includes the “model identification information” in an object creation request and then transmits the object creation request to the personal computer.

<Object Creation Request>

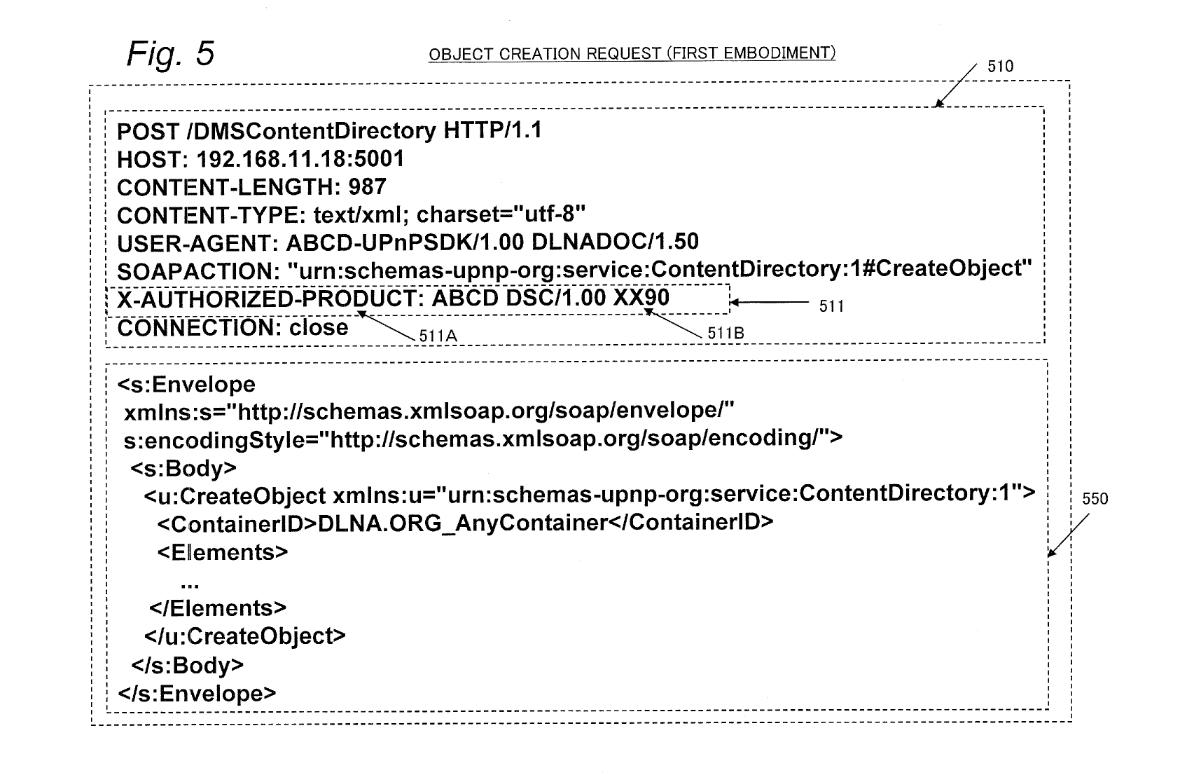

The object creation request will be described by using FIG. 5. FIG. 5 shows an example of the object creation request in the first embodiment.

As illustrated in FIG. 5, the object creation request is transmitted by means of HTTP (Hypertext Transfer Protocol) and can roughly be divided into an HTTP header portion 510 and an HTTP body portion 550. As indicated by being surrounded by a broken line, “model identification information” 511 is added to the HTTP header portion 510. That is, the “model identification information” 511 corresponds to “X-AUTHORIZED-PRODUCT: ABCD DSC/1.00 XX90”. The “model identification information” 511 includes an “extension tag” 511A indicating a protocol extension based on the first embodiment and a “model ID” 511B identifying the model. In the present embodiment, the “extension tag” 511A is “X-AUTHORIZED-PRODUCT:”. The “model ID” 511B is “XX90”. Providing the “model identification information” 511 in the HTTP header portion 510 like in the present embodiment is advantageous in terms of being able to improve the reading speed because the “model identification information” 511 is read starting with the header portion. However, the “model identification information” is not limited to the above example and can be applied as needed such as providing in the body portion 550.

Returning to FIG. 4, when the object creation request is received, the PC 250 checks whether extended information is contained in the object creation request. If extended information is contained in the object creation request, the PC 250 checks whether the extended information is “model identification information”. If the extended information is “model identification information”, the PC 250 reads the value of the “model ID” to determine whether the communication apparatus (the digital camera 100 in the present embodiment) that has transmitted the object creation request is a model from which reception of photos is permitted by the PC 250 based on the value of the “model ID”. In the first embodiment, the digital camera 100 is a model from which reception of photos is permitted by the PC 250 and thus, the PC 250 sets “successful” to the return code of an object creation reply and also sets a valid ID as an object ID before returning the object creation reply to the digital camera (return code=successful, object ID=valid ID) (S407).

<Determination Flow of the Protocol Processor (S407)>

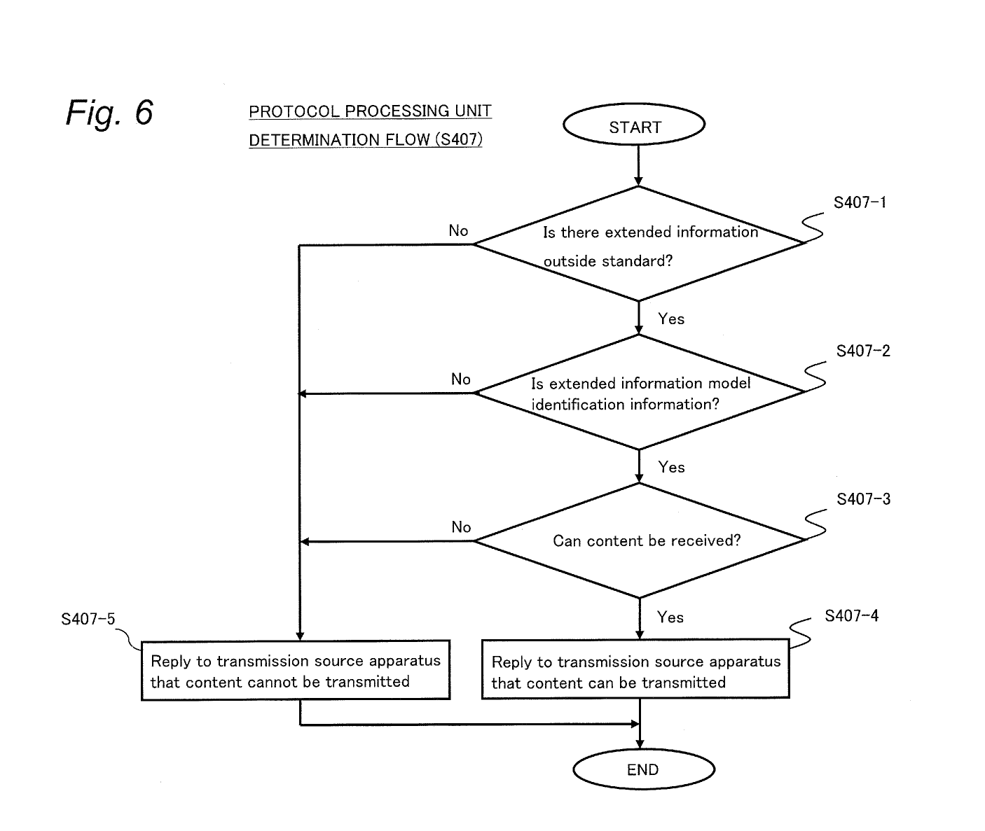

Details of the determination processing by the protocol processor 251 of the PC 250 will be described in step S407 shown above by using FIG. 6.

That is, as illustrated in FIG. 6, when an object creation request is received, the protocol processor 251 of the PC 250 determines whether extended information is contained (S407-1). In the present embodiment, as shown in FIG. 5, the “model identification information” 511 inserted into the header portion 510 of the object creation request contains the “extension tag” 511A as extended information.

If extended information is contained (Yes), the protocol processor 251 checks whether the extended information is “model identification information” (S407-2). In the present embodiment, as shown in FIG. 5, the “extension tag” 511A is the “model identification information” 511.

If the extended information is the “model identification information” (Yes), the protocol processor 251 reads the value of the “model ID” in the “model identification information” to determine whether the communication apparatus (the digital camera 100 in the present embodiment) that has transmitted the object creation request is a model from which reception of photos is permitted by the PC 250 based on the value of the “model ID” (S407-3). In the first embodiment, the protocol processor 251 reads the value of the “model ID” 511B in the “model identification information” 511. Then, the protocol processor 251 compares the value of the read “model ID” 511B by referring to “model ID” information stored in the work memory 252 or the HDD 253. In the present embodiment, the communication apparatus (the digital camera 100 in the present embodiment) that has transmitted the object creation request and the stored “model ID” information match with each other and thus, the communication apparatus is determined to be a model from which reception of photos is permitted by the PC 250.

If the communication apparatus that has transmitted the object creation request is a model from which reception of photos is permitted, the protocol processor 251 sets “successful” to the return code of an object creation reply and also sets a valid ID as an object ID before returning the object creation reply to the digital camera (return code=successful, object ID=valid ID) (S407-4) to terminate the flow (End).

On the other hand, conditions are determined to be not satisfied in one of determinations of steps S407-1 to S407-3 described above (No), the protocol processor 251 sets returns “Content cannot be transmitted” to the communication apparatus of the transmission source (S407-5) to terminate the flow (End).

Returning to FIG. 4, the return code of the object creation reply is successful and thus, the digital camera 100 transmits an upload request (S408). The upload request contains an object ID having been received from the PC 250 for content body (photo data body in the present embodiment) to be uploaded.

The PC 250 returns a reply indicating a successful upload to the digital camera 100 (S409). A photo data upload is completed with the above steps. With the above steps, the communication protocol according to the first embodiment is completed.

[3. Effect]

According to the configuration and operation according to the first embodiment, as described above, at least effects of (1) and (2) described below can be achieved.

(1) Content data can be communicated more appropriately.

In the communication apparatus 100 according to the first embodiment on the transmitting side, as described above, the communication protocol processor 130 that processes a communication protocol based on a predetermined standard includes model identification information of the apparatus in a transmission command defined in the communication protocol (HTTP in the present embodiment) as extended information of the standard (S406). In the present embodiment, as shown in FIG. 5, the “model identification information” 511 constituted of the “extension tag” 511A and the “model ID” 511B is contained in the header portion 510 in an object creation request as the transmission command of HTTP.

Thus, in the communication apparatus 250 according to the first embodiment on the receiving side, when extended information of the standard is contained in a reception command defined by the communication protocol (HTTP), the protocol processor 251 processing the communication protocol based on the standard restricts communication from the data transmission source in accordance with whether the extended information is model identification information. In the present embodiment, as shown in the determination flow in FIG. 6, “Content can be transmitted” is returned to a communication apparatus when first to third determination steps S407-1 to S407-3 are all satisfied (S407-4). In the present embodiment, the communication apparatus 100 is determined to be a model to which content can be transmitted (Yes) and thus, “successful” is set to the return code of an object creation reply and also a valid ID is set as an object ID before the object creation reply being returned (return code=successful, object ID=valid ID) to the digital camera.

Thus, according to the present embodiment, the communication apparatus (a digital camera in the present embodiment) of a client terminal receiving an upload of image data can be restricted. Therefore, the present embodiment is advantageous in terms of being able to prevent uploads like DoS attacks from communication apparatuses of many and unspecified client terminals. As a result, content data can be communicated more appropriately.

(2) Compatibility with image transmitting/receiving systems used widely as standard can be maintained.

The communication apparatus 100 according to the first embodiment on the transmitting side includes, as described above, the communication protocol processor 130 that processes a communication protocol (HTTP in the present embodiment) based on a standard.

Further, the communication apparatus 250 according to the first embodiment on the receiving side also includes the communication protocol processor 251 that processes the communication protocol (HTTP) based on the standard.

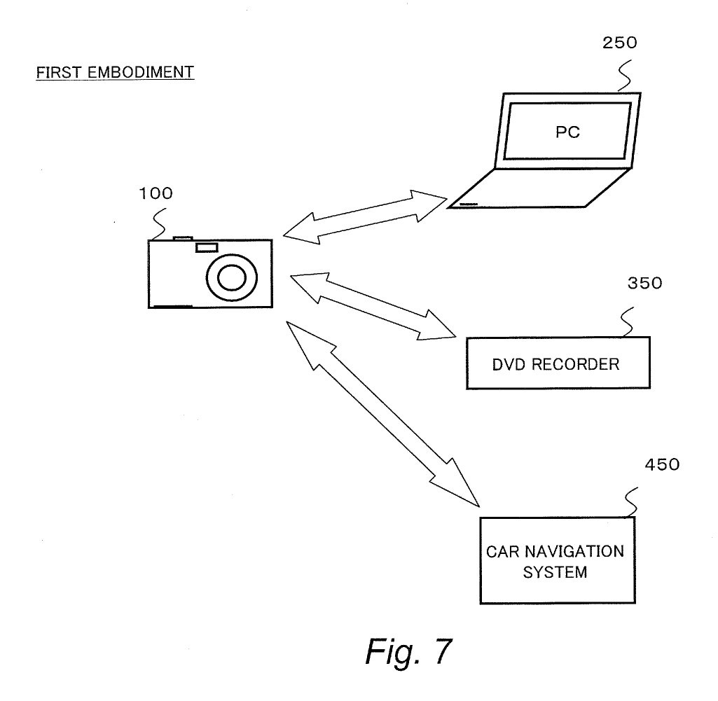

Thus, as shown in FIG. 7, in a communication system according to the first embodiment, communication apparatuses that process the communication protocol (HTTP) based on the standard can communicate with one another. For example, the digital camera 100 in the present embodiment capable of processing the communication protocol (HTTP) can transmit data not only to the PC 250 in the present embodiment, but also to a DVD recorder 350 or a car navigation system 450 based on the same communication protocol (HTTP).

### Second Embodiment (When the Communication Apparatus on the Transmitting Side is a General Example)

Next, the second embodiment will be described. The second embodiment relates to a case where the communication apparatus on the transmitting side is a general communication apparatus (here, called a digital camera 100B) that does not include the protocol processing function of the digital camera 100 in the first embodiment. The PC 250 as a communication apparatus on the receiving side has the same configuration as described above. In the description that follows, descriptions overlapping with those in the first embodiment are omitted.

<Communication Protocol>

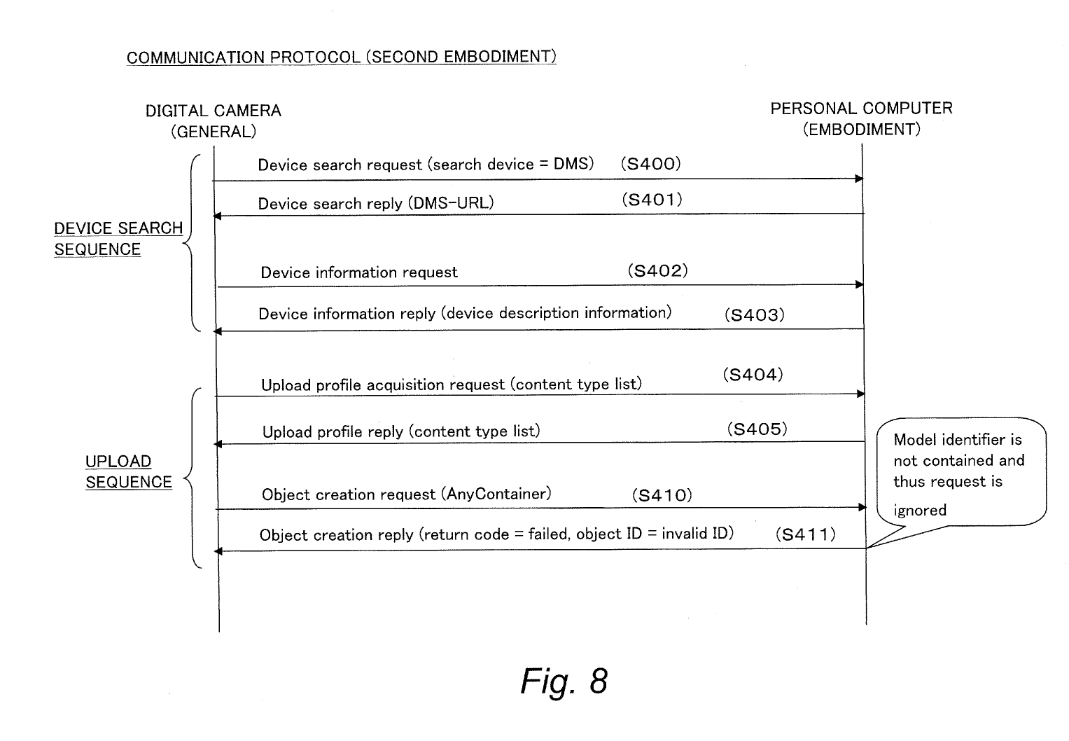

The communication protocol according to the second embodiment will be described by using FIG. 8.

FIG. 8 is a communication sequence diagram to describe communication between a general digital camera and the personal computer 250 in the present embodiment.

The device search (S400 to S403) is the same as in FIG. 4 and thus, the description thereof is omitted and only a photo upload sequence will be described.

First, when a device information reply is received, the digital camera 100B determines whether the PC 250 supports an upload option from the device description information. If the PC 250 does not support the upload option, the digital camera 100B terminates the device search processing.

In the present embodiment, the PC 250 supports the upload option and thus, the digital camera 100B next transmits an upload profile acquisition request to the PC 250 (S404). Incidentally, the digital camera 100B sets a content type list describing content types that can be handled by the local apparatus to the upload profile acquisition request.

When the upload profile acquisition request is received, the PC 250 checks the content type list to create a content type list containing, among content types in the list, only content types supported by the local apparatus and adds the content type list to an upload profile reply to return the upload profile reply to the digital camera 100B (S405).

After making sure that the “device name” of the PC 250 is displayed in the liquid crystal monitor by the device search processing, the user switches the digital camera 100B to the image selection mode according to instructions of the digital camera 100B. In image selection mode, only content types replied as being supported by the PC 250 can be selected as uploadable images. If the user instructs to upload after selecting images, the digital camera 100B transmits an object creation request to the PC 250 (S410).

Because the digital camera 100B is a general communication apparatus, the object creation request is transmitted to the PC 250 without the “model identification information” according to the first embodiment being added thereto.

When the object creation request is received, the PC 250 checks whether extended information is contained. In the present embodiment, no extended information is contained in the object creation request. Thus, the PC 250 determines that the communication apparatus (digital camera 100B) that has transmitted the object creation request is not a model from which reception of photos by the PC 250 is not permitted. Then, the PC 250 sets “failed” to the return code of an object creation reply and also sets an invalid ID as an object ID before returning the object creation reply to the digital camera (return code=failed, object ID=invalid ID) (S411).

Because “failed” is set to the return code of the object creation reply, the digital camera 100B determines that an upload request will not be accepted even if the request is transmitted and stops the processing. At this point, a message like “Photos cannot be uploaded” is displayed in the liquid crystal monitor of the digital camera 100B.

<Effect>

In the second embodiment, as described above, the communication apparatus on the transmitting side is a general communication apparatus (digital camera 100B) that does not include the configuration of the digital camera 100. The PC 250 as the communication apparatus on the receiving side includes the same configuration as that in the first embodiment.

Thus, the digital camera 100B is a general communication apparatus and an object creation request is transmitted to the PC 250 without “model identification information” according to the present embodiment being added thereto (S410). Because the received object creation request contains no extended information, the PC 250 determines that the communication apparatus (digital camera 100B) that has transmitted the object creation request is not a model from which reception of photos by the PC 250 is not permitted (S411). Accordingly, an upload request can be rejected.

### Third Embodiment (When the Communication Apparatus on the Receiving Side is a General Example)

Next, the third embodiment will be described. The third embodiment relates to a case where the communication apparatus on the receiving side is a general communication apparatus (here, called a PC 250B) that does not include the protocol function of the PC 250 in the first embodiment. The digital camera 100 as a communication apparatus on the transmitting side has the same configuration as described in the first embodiment. In the description that follows, descriptions overlapping with those in the first embodiment are omitted.

<Communication Protocol>

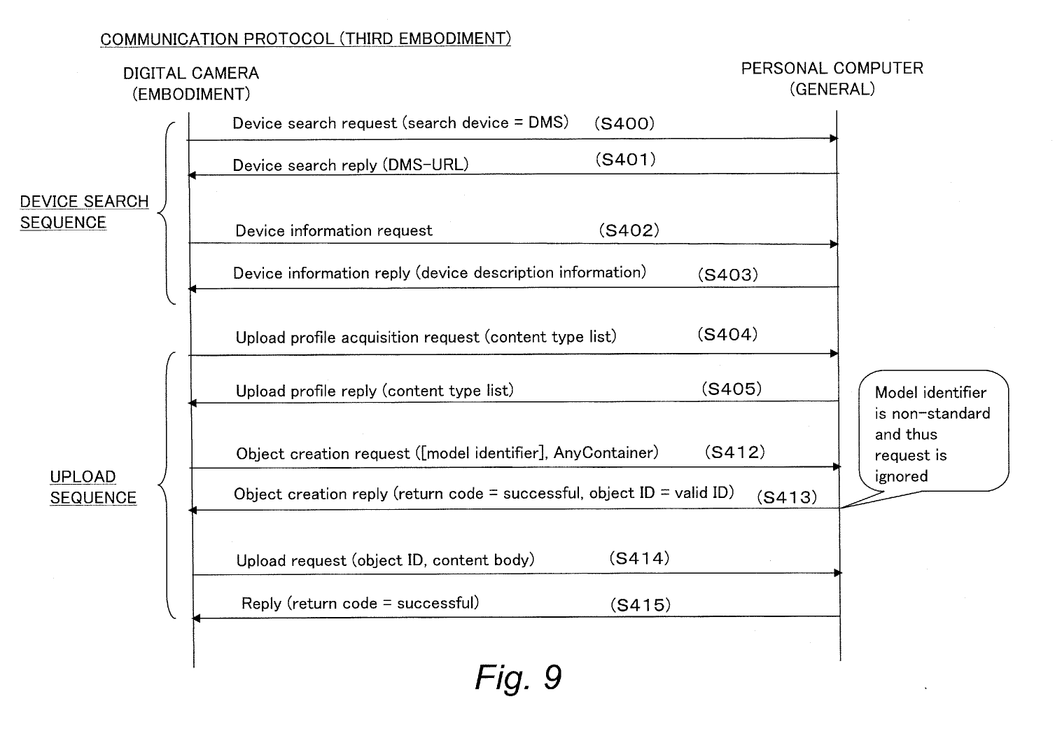

FIG. 9 is a communication sequence diagram to describe communication between the general digital camera 100 and the PC 250B according to the third embodiment. The device search (S400 to S403) is the same as in FIG. 4 and thus, the description thereof is omitted and only a photo upload sequence will be described.

First, when a device information reply is received, the controller 130 of the digital camera 100 determines whether the PC 250B supports an upload option from device description information. If the PC 250B does not support the upload option, the digital camera 100 terminates the device search processing by displaying “Transmission destination cannot be found” in the liquid crystal monitor 123.

In the present embodiment, the PC 250B supports the upload option and thus, the digital camera 100 next transmits an upload profile acquisition request to the PC 250B (S404). Incidentally, the digital camera 100 sets a content type list describing content types that can be handled by the local apparatus to the upload profile acquisition request.

Subsequently, when the upload profile acquisition request is received, the PC 250B checks the content type list to create a content type list containing, among content types in the list, only content types supported by the local apparatus and adds the content type list to an upload profile reply to return the upload profile reply to the digital camera 100 (S405).

After making sure that the “device name” of the PC 250B is displayed in the liquid crystal monitor by the device search processing, the user switches the digital camera to the image selection mode according to instructions of the digital camera 100. In image selection mode, only content types replied as being supported by the PC 250B can be selected as uploadable images. If the user instructs to upload after selecting images, the digital camera 100 transmits an object creation request to the personal computer (S412).

In the third embodiment, in step S412, the digital camera 100 adds “model identification information” that is not defined in the DMS-UPLOAD standard protocol to the object creation request as extended information and then transmits the object creation request to the PC 250B. The “model identification information” includes an “extension tag” indicating a similar protocol extension and a “model ID” identifying the model. In the present embodiment, a value indicating the digital camera 100 in the present embodiment is set to the “model ID”. The digital camera 100 includes the “model identification information” in an object creation request and then transmits the object creation request to the PC 250B.

The PC 250B receiving the object creation request is, as described above, a general communication apparatus. Thus, whether extended information is contained may be checked or may not be checked. If not checked, the PC 250B regards the object creation request as an object creation request according to the DMS-UPLOAD standard protocol. If checked, the PC 250B can confirm the presence of extended information, but the general PC 250B does not know the definition of “model identification information” and processes the “model identification information” as information that cannot be understood. According to the DMS protocol, if extended information contains information that cannot be understood, the information is ignored and the object creation request is regarded as an object creation request in the DMS-UPLOAD standard protocol.

In any of the above cases, as described above, the PC 250B regards and processes an object creation request from the digital camera 100 as an object creation request in the DMS-UPLOAD standard protocol. Then, the PC 250B sets “successful” to the return code of an object creation reply and also sets a valid ID as an object ID before returning the object creation reply to the digital camera (return code=successful, object ID=valid ID) (S413).

Subsequently, because “successful” is set to the return code of the object creation reply, the digital camera 100 transmits an upload request (S414). The upload request contains the object ID having been received from the personal computer for content body (photo body in this case) to be uploaded. For the sequence shown in FIG. 9, the PC 250B is a general PC, instead of the communication apparatus 250 according to the present embodiment, and thus, the digital camera 100 can transmit photos.

Subsequently, the PC 250 returns a reply indicating a successful upload to the digital camera 100 (S415).

<Effect>

In the third embodiment, as described above, the communication apparatus on the receiving side relates to a general communication apparatus (here, the PC 250B). The digital camera 100 as the communication apparatus on the transmitting side includes the same configuration as that in the first embodiment.

Thus, the digital camera 100 adds “model identification information” that is not defined in the DMS-UPLOAD standard protocol to an object creation request as extended information and transmits the object creation request to the PC 250.

On the other hand, the PC 250B having received the object creation request ignores extended information because the information cannot be understood according to the DMS protocol and regards the object creation request as an object creation request according to the DMS-UPLOAD standard protocol.

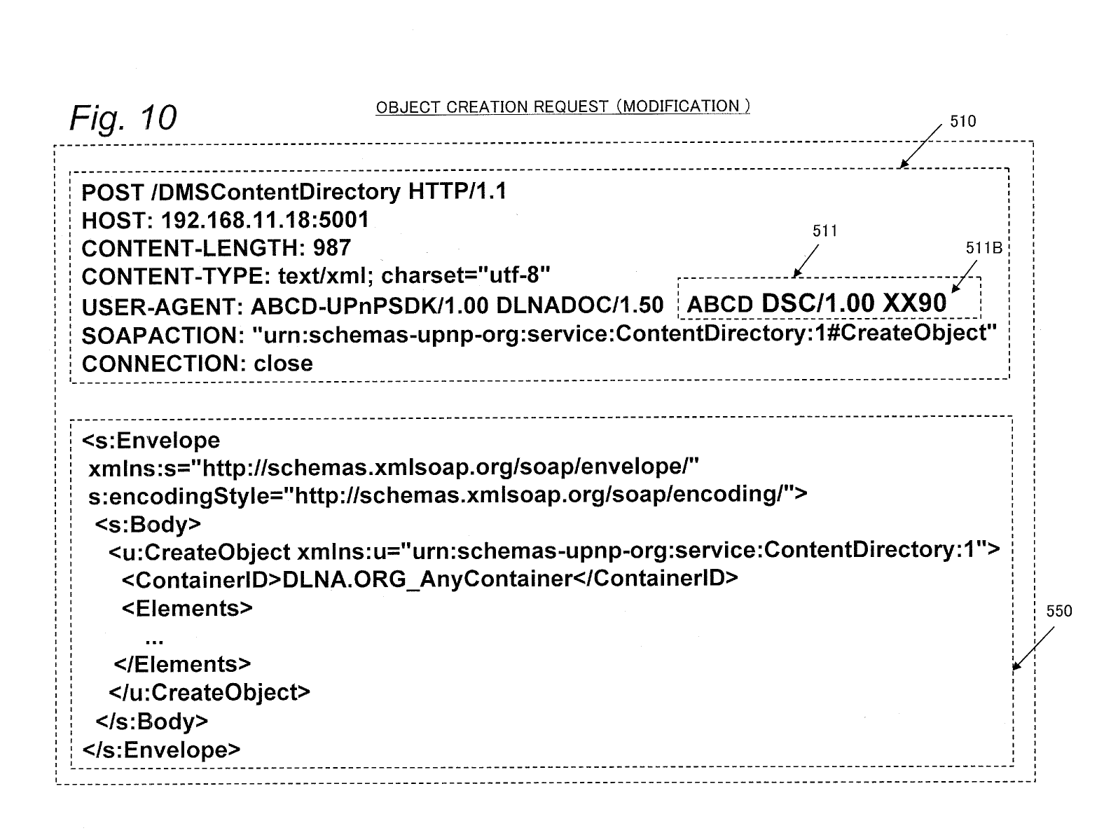

Embodiments are not limited to the above embodiments and modified embodiments such as alterations, substitutions, additions, and omissions can appropriately be applied. For example, a modification of the object creation request will be described by using FIG. 10. FIG. 10 shows an exemplary modification of the object creation request. As illustrated in FIG. 10, the object creation request in the modification is transmitted by means of the HTTP protocol and is roughly divided into the HTTP header portion 510 and the HTTP body portion 550. In the present modification, “ABCD DSC/1.00 XX90” added to the HTTP header portion 510 corresponds to the “model identification information” 511. Similarly, the “model ID” 511B is “XX90”. FIG. 10 is different from FIG. 5 in that the “model identification information” 511 is added as a standard tag value used to identify “USER-AGENT” as the transmission source client.

As described above, an object creation request like the present modification can also be applied. Similarly, the “model identification information” 511 can also be added to the HTTP body portion 550, as well as to the HTTP header portion 510.

### Fourth Embodiment (Relationship to a General Communication Apparatus)

Next, the fourth embodiment will be described. The fourth embodiment describes a communication system constituted of a communication apparatus according to the present embodiment (that is, a digital camera 100A, a PC 250A and the like having a function of specific protocol processing) and a general communication apparatus (the digital camera 100B, the PC 250B and the like having no function of specific protocol processing).

In the first and second embodiments, as described with reference to FIGS. 4 and 8, the PC 250A as a communication apparatus in the present embodiment can realize reception permission of photo transmission from the digital camera 100A as a communication apparatus in the present embodiment and reception rejection of photo transmission from the general digital camera 100B by the same communication protocol (HTTP in the present embodiment).

In the first and third embodiments, as described with reference to FIGS. 4 and 9, the digital camera 100A as a communication apparatus in the present embodiment can upload and transmit photos to the PC 250A as a communication apparatus in the present embodiment and the general PC 250B by the same communication protocol (HTTP).

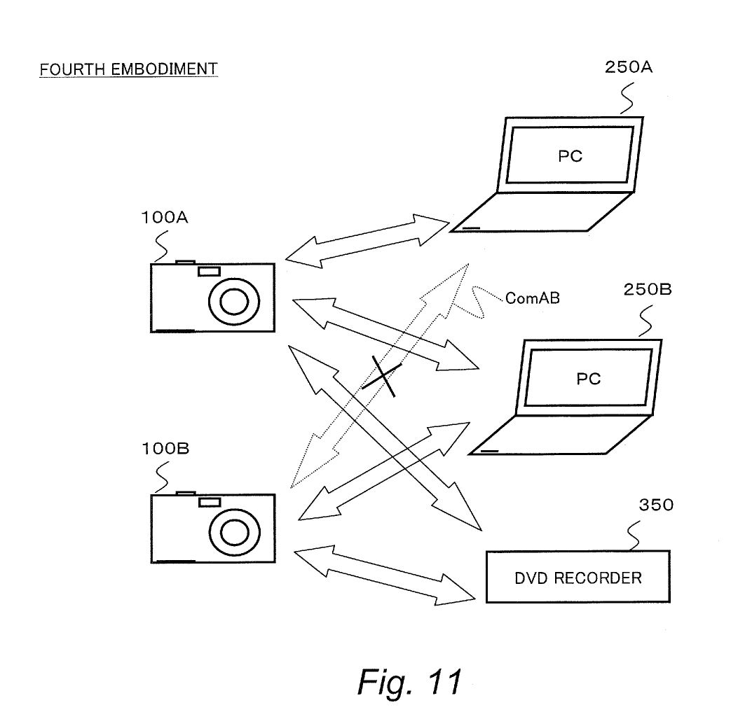

The above relationship in the communication system can be summarized as shown in FIG. 11.

As illustrated in FIG. 11, the PC 250A as a communication apparatus in the present embodiment permits, as described in the first embodiment, reception of transmission of photo data from the digital camera 100A as a communication apparatus in the present embodiment by means of the predetermined communication protocol (HTTP).

On the other hand, as indicated by a broken line ComAB in FIG. 11, the PC 250A as a communication apparatus in the present embodiment rejects, as described in the second embodiment, reception of transmission of photo data from the general digital camera 100B by the same communication protocol (HTTP).

Also as described in the first embodiment, the digital camera 100A as a communication apparatus in the present embodiment can upload and transmit photo data to the PC 250A as a communication apparatus by means of the communication protocol (HTTP).

On the other hand, as described in the third embodiment, the digital camera 100A as a communication apparatus in the present embodiment can upload and transmit photo data to the general PC 250B by the same communication protocol (HTTP).

Thus, according to the present embodiment, up load transmission of the communication apparatus (the digital camera 100B in the present embodiment) of the client terminal of the transmission source receiving an upload of image data can be restricted. Therefore, the PC 250A can prevent uploads like DoS attacks from communication apparatuses (100B) of many and unspecified client terminals.

In addition, according to the present embodiment, communication apparatuses that process the communication protocol (HTTP) based on the predetermined standard can communicate with one another. For example, the digital camera 100A capable of processing the communication protocol (HTTP) can transmit data not only to the PC 250A in the present embodiment, but also to the PC 250B as a general communication apparatus, the DVD recorder 350 and the like by means of the same communication protocol (HTTP) so that compatibility can be maintained.

In the foregoing, the embodiments have been described as illustrations of technology according to the present disclosure. For the illustrations, appended drawings and detailed descriptions are provided. Thus, among structural elements described in the appended drawings and detailed descriptions, not only structural elements required for problem solving, but also structural elements that are not required for problem solving and are shown to illustrate the technology may be contained. Thus, structural elements that are not required for problem solving should not be immediately regarded as required based on the fact that such structural elements that are not required for problem solving are described appended drawings or detailed descriptions. In addition, the above embodiments are intended to illustrate the technology in the present disclosure and therefore, various alterations, substitutions, additions, and omissions can be made within the scope of claims or equivalents thereof.

### INDUSTRIAL APPLICABILITY

The application of embodiments is not limited to digital cameras and personal computers as communication apparatuses. For example, embodiments can also be applied naturally to communication apparatuses provided with a communication unit such as movie cameras and smart phones or communication systems connecting such communication apparatuses via a LAN.

What is claimed is:

1. A communication apparatus, comprising:
a communication protocol processor configured to process a communication protocol based on a predetermined standard; and
a communication unit configured to perform communication processing with a communication apparatus of a transmission destination of data under a control of the communication protocol processor, wherein
the communication protocol processor includes model identification information of the communication apparatus in a transmission command defined in the communication protocol as extended information of the predetermined standard.

2. The communication apparatus according to claim 1, wherein the model identification information is arranged in a header portion of the transmission command.

3. The communication apparatus according to claim 1, wherein the model identification information has a model ID of the communication apparatus.

4. The communication apparatus according to claim 1, wherein the communication protocol is HTTP.

5. The communication apparatus according to claim 1 being an imaging apparatus that images a subject to generate image data.

6. A communication apparatus, comprising:
a communication protocol processor configured to process a communication protocol based on a predetermined standard; and
a communication unit configured to perform communication processing with a communication apparatus of a transmission source of data under a control of the communication protocol processor, wherein
when extended information of the predetermined standard is contained in a received command defined in the communication protocol, the communication protocol processor restricts communication from the communication apparatus as the transmission source of the data in accordance with whether or not the extended information is model identification information.

7. The communication apparatus according to claim 6, wherein the model identification information is arranged in a header portion of the received command.

8. The communication apparatus according to claim 6, wherein the model identification information has a model ID of the communication apparatus as the transmission source of the data.

9. The communication apparatus according to claim 6, wherein the communication protocol is HTTP.

10. The communication apparatus according to claim 8, wherein the communication protocol processor:
determines whether the extended information is the model identification information when the received command is received; and
reads a value of the model ID in the model identification information and determines whether the communication apparatus that has transmitted the received command is an apparatus which is to be allowed to receive the data from the communication apparatus based on the value of the model ID, when the extended information is the model identification information.

11. The communication apparatus according to claim 6 being a personal computer.

12. A communication system comprising:
a first communication apparatus including a first protocol processor configured to process a communication protocol based on a predetermined standard and a first communication unit configured to perform communication processing with a communication apparatus as a transmission destination of data under a control of the first protocol processor; and
a second communication apparatus including a second protocol processor configured to process the communication protocol based on the predetermined standard and a second communication unit configured to perform the communication processing with the communication apparatus as a transmission source of the data under the control of the second protocol processor, wherein
the first protocol processor includes model identification information of the first communication apparatus in a transmission command defined according to the communication protocol, as extended information of the predetermined standard, and
when the extended information of the predetermined standard is contained in a received command defined in the transmitted communication protocol, the second protocol processor restricts communication from the first communication apparatus in accordance with whether or not the extended information is model identification information.
